(19) United States
(12) Patent Application Publication
(10) Pub. No.: US 2003/0019138 A1
(43) Pub. Date: Jan. 30, 2003

(54) Advertising sign device

(76) Inventor: Yuan Lin, Vic (AU)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 09/915,863

(22) Filed: Jul. 26, 2001

(51) Int. Cl. G09F 13/28

(52) U.S. Cl. 40/550

(57) ABSTRACT

An advertising sign device comprising an abutment plate including receptacles arranged in a predetermined order each having a seat, a lamp assembly including a plurality of serially connected lamps mounted on the seats, a back plate, and a cover. Advantages, such as quick assembly and colorful scheme of lamp assembly, easy replacement of lamps, prolonged useful life, lower manufacturing cost, and safety are achieved.

### BACKGROUND OF THE INVENTION

1. Field of the Invention

The present invention relates to billboards and more particularly to an advertising sign device with improved characteristics.

2. Description of Related Art

The light source of a conventional billboard may be broken down into two categories. Namely, one is a fluorescent lamp and the other is a neon lamp. In general, neon lamps are widely employed since they can emit a red light (i.e., colorful so as to easily catch people's attention) when energized. However, the prior art suffered from several disadvantages. For example, neon lamps are costly to manufacture. Further, a number of associated devices such as a starter, transformer, frequency transformer, etc. are needed, which in turn increase the total cost. Furthermore, once a neon lamp has malfunctioned, the whole billboard has to be replaced. This adversely affects maintenance. Additionally, neon lamps are high frequency light sources, thus being subject to interference by electrical signal transmission. Also, such a high frequency light source is harmful to human eyes. Thus, it is desirable to provide an improved advertising sign device in order to overcome the above drawbacks of prior art.

### SUMMARY OF THE INVENTION

It is an object of the present invention to provide an advertising sign device comprising an abutment plate including a plurality of receptacles arranged in a predetermined sign pattern, a plurality of lamps mounted on the respective receptacles—each lamp having two outer electrodes, each electrode being interconnected with two of the adjacent lamps in back of the abutment plate—whereby a series of connected lamps, arranged in accordance with the predetermined sign pattern is formed to thereby achieve a desired lighting advertising sign pattern.

It is another object of the present invention to provide an advertising sign device comprising an abutment plate including a plurality of receptacles arranged in a predetermined sign pattern, a plurality of lamps mounted on the respective receptacles, each lamp being electrically connected to the other two adjacent lamps in a back of the abutment plate, whereby a series of connections in combination with upper and lower parallel connected lamps arranged in accordance with the predetermined sign pattern is formed and the total voltage drops of each series connected lamps is substantially equal to or greater than that of the power supply so as to obtain a safe and prolonging advertising sign device.

It is still another object of the present invention to provide an advertising sign device comprising an abutment plate including a plurality of receptacles arranged in a predetermined sign pattern, a lamp assembly including a plurality of light emitting diode (LED) lamps mounted on a first surface of the abutment plate, each LED lamp being electrically connected to the mating electrodes of the other two adjacent LED lamps in a second surface of the abutment plate; whereby a series of connections in combination with upper and lower parallel connected LED lamps arranged in accordance with the predetermined sign pattern is formed to thereby attain a desired light-emitting advertising sign pattern.

Accordingly, the present invention provides an advertising sign device comprising:

an abutment plate having a first surface and an opposing second surface, said abutment plate further including a plurality of receptacles arranged in a predetermined sign pattern on the first surface, wherein each receptacle has a first aperture and a second aperture both extending to the second surface, and a seat between the first and second apertures;

a lamp assembly including a plurality of lamps, each mounted on one of the receptacles on the seat thereof and each lamp having a first electrode communicating with the first aperture and a second electrode communicating with second aperture of said one receptacle, wherein the first electrode of one lamp is electrically connected to the second electrode of an adjacent lamp through the first aperture and second aperture of the respective receptacles, whereby forming a series electrical connection of the lamps so as to allow the lamps in the series to be lit as one light emitting letter or one sign or figure.

According to the present invention, the first electrode extends through the first aperture to the second surface and the second electrode extends through the second aperture to the second surface of the abutment plate so that the first electrode of one lamp is physically in contact with the second electrode of an adjacent lamp for making the electrical connection.

According to the present invention, the advertising sign device further comprises a plurality of conductors each having a first end and second end, wherein the first end is inserted into the first aperture of one receptacle for contacting the first electrode communicating with said first aperture and the second end is inserted into the second aperture of an adjacent receptacle for contacting the second electrode communicating with said second aperture.

According to the present invention, the first end of each conductor has side projections for securing the first end to the first aperture in which said first end is inserted, and the second end of each conductor has side projections for securing the second end to the second aperture in which said second end is inserted.

According to the present invention, the advertising sign device further comprises a back plate secured to the abutment plate for covering at least one part of the second surface of the abutment plate.

According to the present invention, the advertising sign device further comprises a cover plate secured to the abutment plate on top of the first surface thereof for protecting the lamps while allowing the light emitting letter or sign or figure to be seen through the cover plate.

According to the present invention, the conductors are placed in grooves on the second surface of the abutment plate.

According to the present invention, each lamp comprises a light-emitting diode.

According to the present invention, the first electrode of one lamp is electrically connected to the second electrode of an adjacent lamp through a resistor.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of advertising sign device according to the invention;

FIG. 2 is an exploded perspective view of FIG. 1;

FIG. 2A is an exploded perspective view of a partial section showing a portion of abutment plate prior to the assembly of lamps;

FIG. 3 is a cross-sectional view similar to FIG. 2A where a lamp has been mounted and another lamp has not been mounted;

FIG. 4 is a cross-sectional view of a second preferred embodiment of advertising sign device according to the invention where lamps have been mounted but not electrically connected together;

FIG. 4A is a view similar to FIG. 4 where lamps have been electrically connected together;

FIG. 5 is a perspective view of a partial section of a third preferred embodiment of advertising sign device according to the invention where LED lamps have been mounted but not electrically connected together;

FIG. 5A is a view similar to FIG. 5 where LED lamps have been electrically connected together;

FIG. 6 is an exploded perspective view of a fourth preferred embodiment of advertising sign device according to the invention;

FIG. 7 is a perspective view of another configuration of abutment plate; and

FIG. 8 is a front plan view of FIG. 7.

### DETAILED DESCRIPTION OF THE PREFERRED EMBODIMENTS

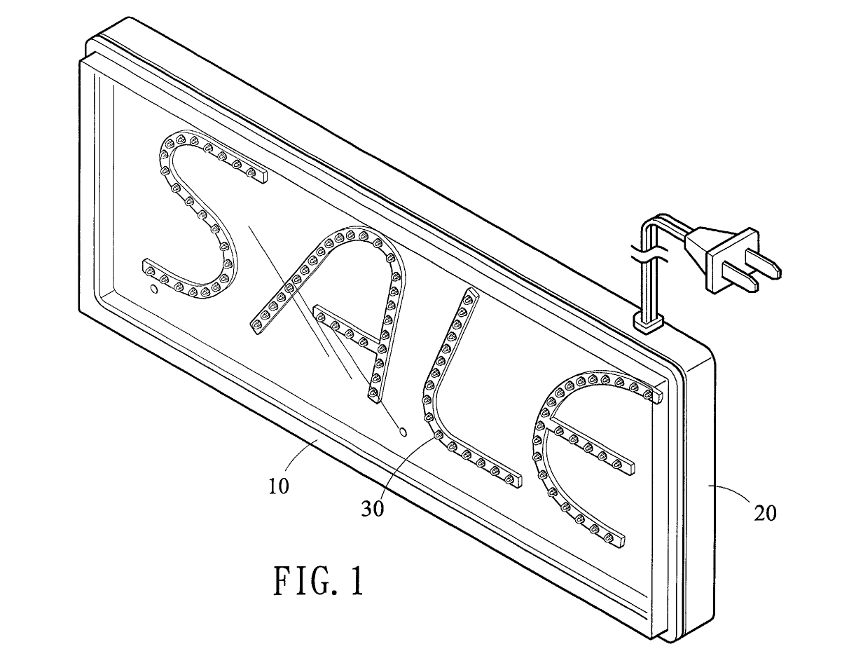

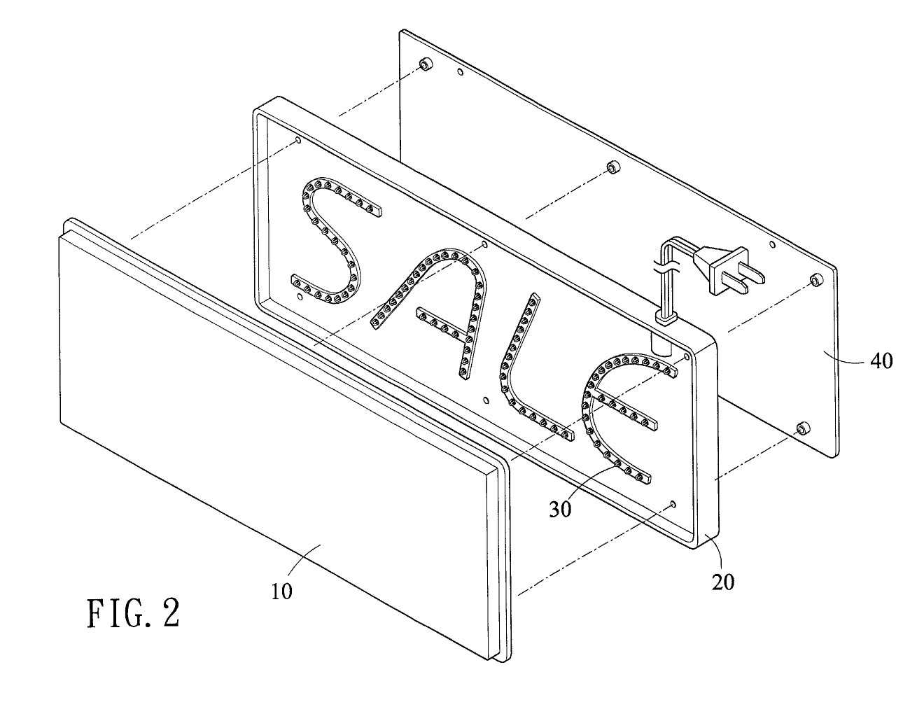

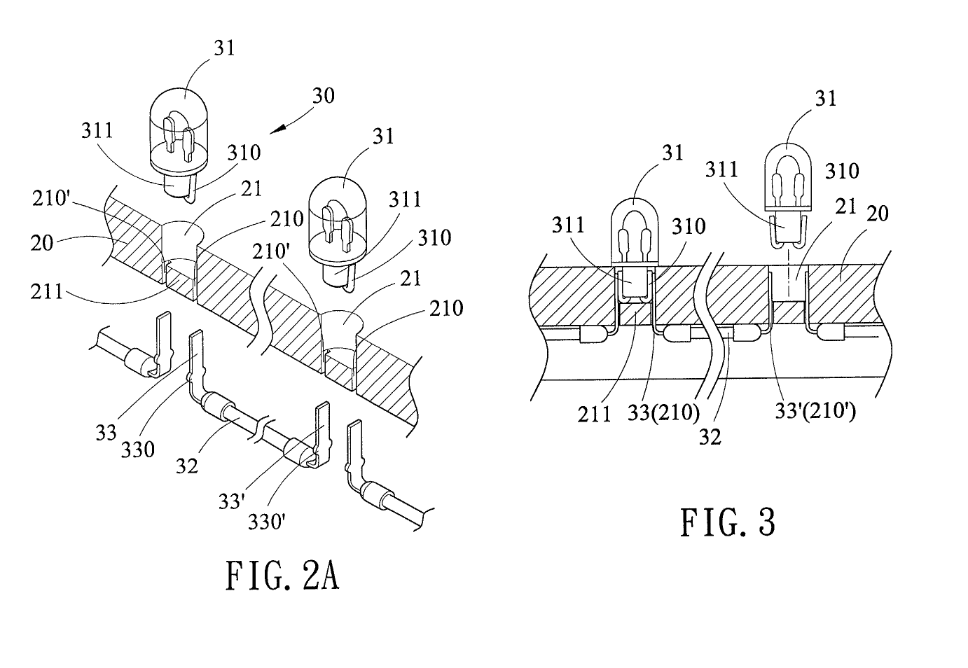

FIGS. 1 to 3 show an advertising sign device constructed in accordance with a first preferred embodiment of the invention. The device comprises an abutment plate 20, a lamp assembly 30, a transparent cover 10 for protecting abutment plate 20 and lamp assembly 30, and a back plate 40 being threadedly secured together. As shown in FIG. 2A, the rectangular abutment plate 20 comprises a plurality of receptacles 21 arranged in a predetermined pattern so as to show a desired advertising sign or figure. Each receptacle 21 comprises a first aperture 210, a second aperture 210′, and a seat 211 sandwiched between apertures 210 and 210′. Lamp assembly 30 comprises a plurality of lamps 31 each having a base 311 and two outer electrodes 310. Two adjacent lamps 31 are electrically connected together by a conductor 32 having two end contacts 33 and 33′. Two opposite projections 330 (or 330′) are formed on contact 33 (or 33′). In the assembly, lamps 31 are placed on seats 211. Then, contacts 33 and 33′ are inserted into apertures 210 and 210′ respectively. With the provision of projections 330 and 330′, the engagement of contacts 33 and 33′ and apertures 210 and 210′ are secured. This forms a series of electrical connections of lamps 31 at the back of the abutment plate to show one light emitting letter or one sign or figure. It is also understood that the total voltage drops of the series of connected lamps 31 is equal to or greater than that of the voltage of the power supply. The advantages of the invention are quick assembly, safe usage and colorful scheme of lamp assembly 30; easy replacement of lamps 31; prolonged useful life and lamps 31 are less expensive than conventional neon lamps.

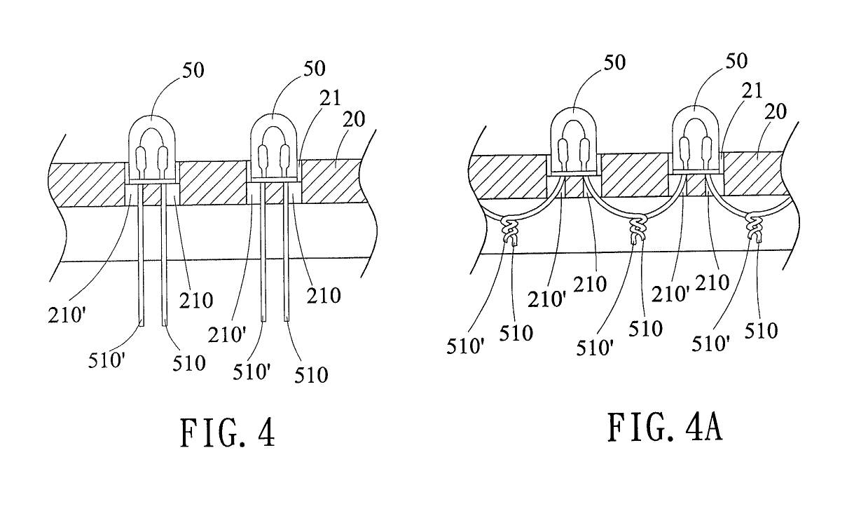

FIGS. 4 and 4A show a second preferred embodiment of advertising sign device according to the invention. The conductors 32 in the first embodiment are eliminated. Hence, electrodes 510 and 510′ of one lamp 50 are electrically and directly connected with the corresponding electrodes 510′ and 510 of the other adjacent lamp 50 in the back of the abutment plate 20, respectively (i.e., threaded connection, as shown).

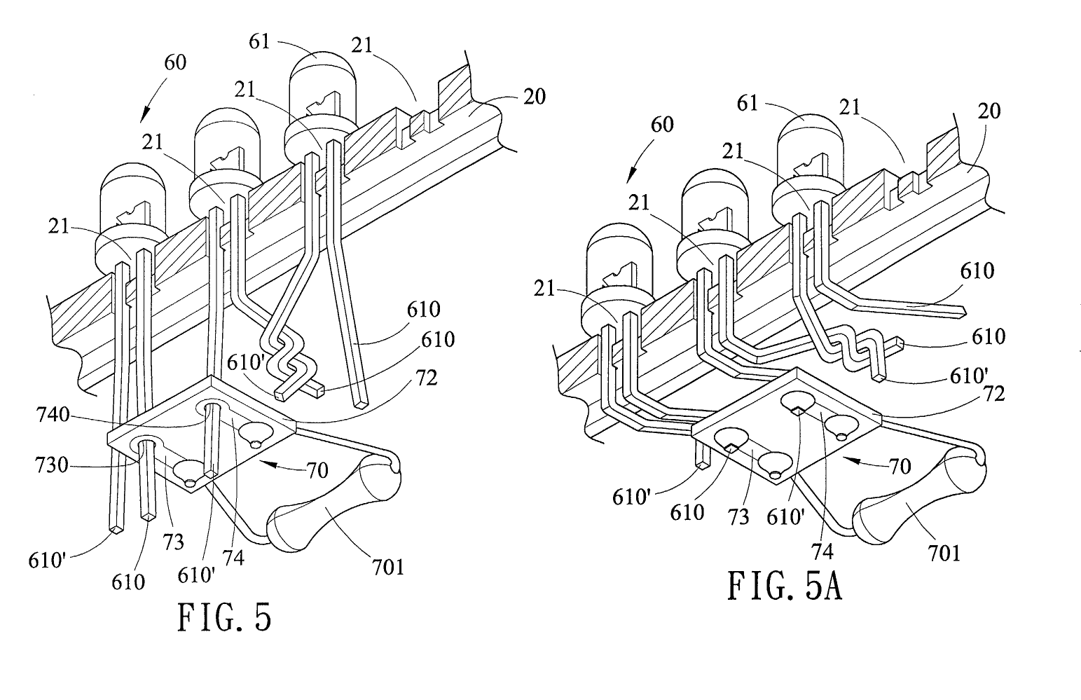

FIGS. 5 and 5A show a third preferred embodiment of advertising sign device according to the invention. The lamps 50 in second embodiment are replaced by LED lamps 60. Further, a plurality of resistor assemblies 70 are provided on the back side of abutment plate 20. Each resistor assembly 70 is electrically connected between electrode 610 of one LED lamp 61 and electrode 610′ of the other adjacent LED lamp 61. In detail, resistor assembly 70 comprises a board 72, a resistor 701 connected to board 72, a first hole 730 with electrode 610 of one LED lamp 61 secured therein, a first connection 73 interconnecting first hole 730 and one terminal of resistor 701, a second hole 740 with electrode 610′ of the other LED lamp 61 secured therein, and a second connection 74 interconnecting second hole 740 and the other terminal of resistor 701. With the provision of resistor assembly 70, the excessive heat generated by LED lamps 61 may be effectively dissipated.

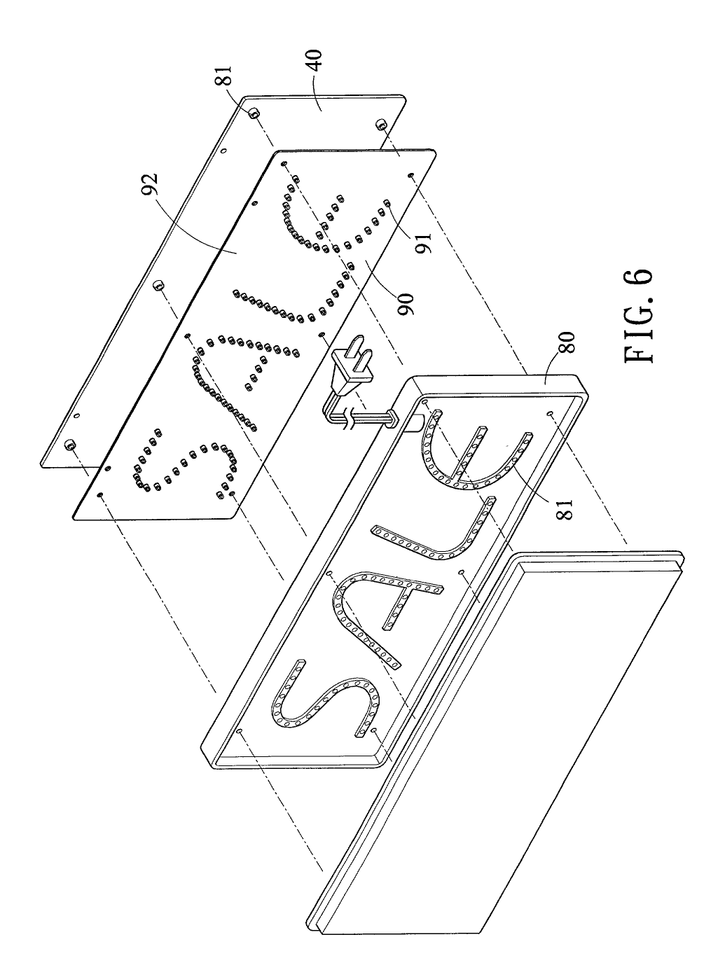

FIG. 6 shows a fourth preferred embodiment of advertising sign device according to the invention. An additional printed circuit board (PCB) 90 having a printed circuit on the second surface thereof is provided with LED lamps 91 mounted on the first surface thereof to show a predetermined word pattern, as shown in FIGS. 1 and 2 (e.g., SALE, as shown) instead of the previous conductor 32 or lamp electrodes' direct connection. Correspondingly, a plurality of through holes 81 are formed on abutment plate 80 with each LED lamp 91 projected from a through hole 81. Also, PCB 90 is threadedly secured together with the abutment plate 80.

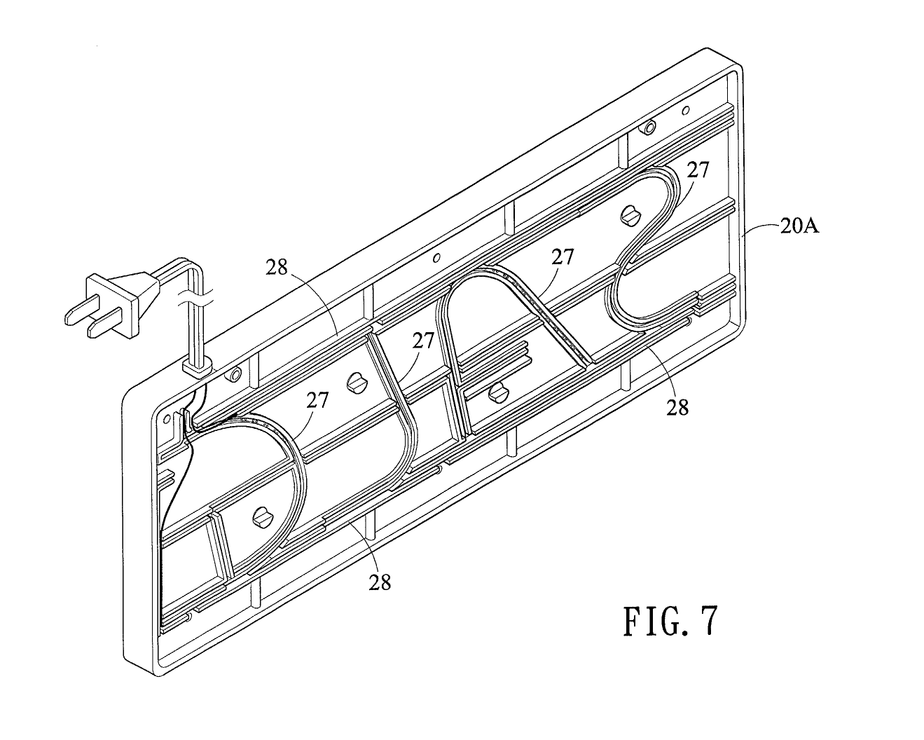

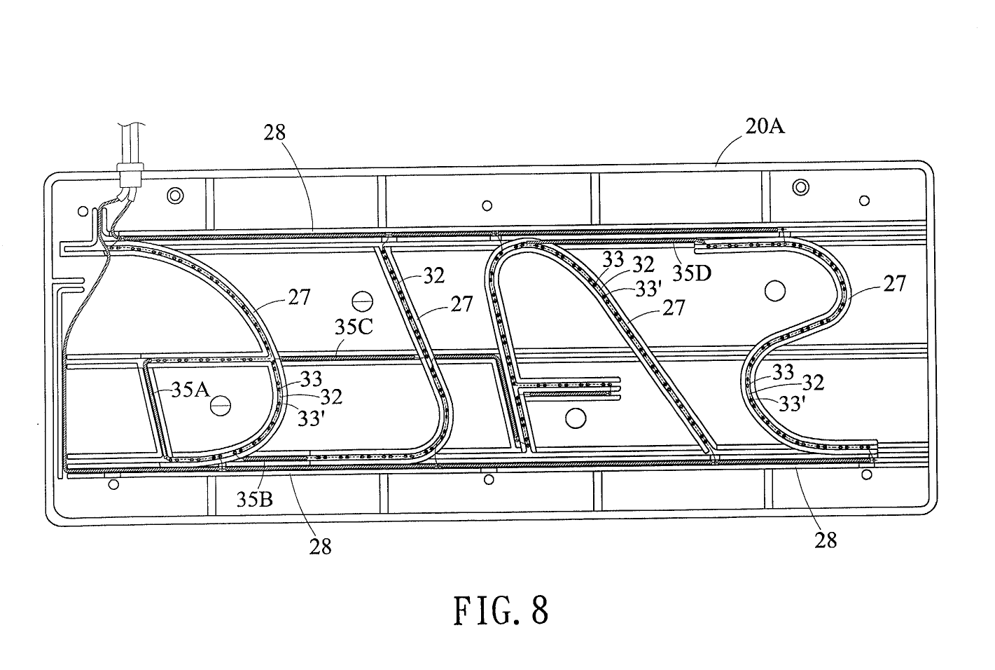

FIGS. 7 and 8 show another configuration of abutment plate 20A, wherein a plurality of arcuate grooves 27 and two parallel grooves 28 in communication with arcuate grooves 27 are formed on the back surface of abutment plate 20A. Within the grooves 27 are a plurality of lamp electrodes 33, 33′ of the lamp assembly and a plurality of conductors 32, which are electrically interconnected between each of electrodes 33, 33′. A plurality of interconnecting conductors 35A-35D are electrically connected between each predetermined word or sign pattern. For example, conductor 35A interconnects within the word pattern “E”, conductor 35B between word patterns “E” and “L”, conductor 35C between word patterns “E” and “A” and conductor 35D between word patterns “A” and “S”. This ensures a neat and safe arrangement of lamp assembly, thus preventing a short circuit from occurring.

While the invention herein disclosed has been described by means of specific embodiments, numerous modifications and variations could be made thereto by those skilled in the art without departing from the scope and spirit of the invention set forth in the claims.

1. An advertising sign device comprising:
an abutment plate having a first surface and an opposing second surface, said abutment plate further including a plurality of receptacles arranged in a predetermined sign pattern on the first surface, wherein each receptacle has a first aperture and a second aperture both extending to the second surface, and a seat between the first and second apertures;
a lamp assembly including a plurality of lamps, each mounted on one of the receptacles on the seat thereof and each lamp having a first electrode communicating with the first aperture and a second electrode communicating with second aperture of said one receptacle, wherein the first electrode of one lamp is electrically connected to the second electrode of an adjacent lamp through the first aperture and second aperture of the respective receptacles, whereby forming a series electrical connection of the lamps so as to allow the lamps in the series to be lit as one light emitting letter or one sign or figure.

2. The advertising sign device of claim 1, wherein the first electrode extends through the first aperture to the second surface and the second electrode extends through the second aperture to the second surface of the abutment plate so that the first electrode of one lamp is physically in contact with the second electrode of an adjacent lamp for making the electrical connection.

3. The advertising sign device of claim 1, further comprising a plurality of conductors each having a first end and second end, wherein the first end is inserted into the first aperture of one receptacle for contacting the first electrode communicating with said first aperture and the second end is inserted into the second aperture of an adjacent receptacle for contacting the second electrode communicating with said second aperture.

4. The advertising sign device of claim 3, wherein the first end of each conductor has side projections for securing the first end to the first aperture in which said first end is inserted, and the second end of each conductor has side projections for securing the second end to the second aperture in which said second end is inserted.

5. The advertising sign device of claim 1, further comprising a back plate secured to the abutment plate for covering at least one part of the second surface of the abutment plate.

6. The advertising sign device of claim 1, further comprising a cover plate secured to the abutment plate on top of the first surface thereof for protecting the lamps while allowing the light emitting letter or sign or figure to be seen through the cover plate.

7. The advertising sign device of claim 1, wherein the conductors are placed in grooves on the second surface of the abutment plate.

8. The advertising sign device of claim 1, wherein each lamp comprises a light-emitting diode.

9. The advertising sign device of claim 8, wherein the first electrode of one lamp is electrically connected to the second electrode of an adjacent lamp through a resistor.
